(19) United States
(12) Patent Application Publication
(10) Pub. No.: US 2003/0062071 A1
(43) Pub. Date: Apr. 3, 2003

(54) Dense-phase fluid cleaning system utilizing ultrasonic transducers

(76) Inventors: Nelson W. Sorbo, Torrance, CA (US); Carl W. Townsend, Los Angeles, CA (US); Gilbert E. Henderson, Covina, CA (US)

Correspondence Address: PATENT DOCKET ADMINISTRATION, RAYTHEON SYSTEMS COMPANY, P.O. BOX 902 (E1/E150), BLDG E1 M S E150, EL SEGUNDO, CA, 90245-0902, US

(21) Appl. No.: 10/255,505

(22) Filed: Sep. 26, 2002

Related U.S. Application Data
(60) Provisional application No. 60/325,620, filed on Sep. 28, 2001.

(51) Int. Cl. B08B 3/00

(52) U.S. Cl. 134/184; 134/109

(57) ABSTRACT

A cleaning system utilizing a pressurized dense-phase cleaning fluid includes a cleaning containment vessel having a containment-vessel interior, and a pressurization source in fluid communication with the containment-vessel interior to produce a cleaning pressure therein. There is at least one ultrasonic energy source directing ultrasonic energy into the containment-vessel interior. Where there are two ultrasonic energy sources, they desirably function at different frequencies. Each ultrasonic energy source includes a transducer housing having a transducer-housing interior, an ultrasonic transducer within the transducer-housing interior and directing a beam of ultrasonic energy through the transducer housing and into the containment-vessel interior, and a gas-pressure source in fluid communication with the transducer-housing interior. The gas-pressure source produces a pressure in the transducer-housing interior substantially equal to the cleaning pressure.

This application claims the benefit of and priority to U.S. Provisional Application No. 60/325,620, filed Sep. 28, 2001, the disclosure of which is incorporated herein by reference.

This invention relates to a non-aqueous cleaning system wherein a dense-phase cleaning fluid is pressurized and, more particularly, to such a cleaning system wherein the cleaning action is accelerated by ultrasonic energy introduced into the dense-phase cleaning fluid.

### BACKGROUND OF THE INVENTION

The application of ultrasonic energy has long been used to accelerate cleaning processes. In one approach, the article to be cleaned is immersed in a liquid cleaning medium such as a solvent, and ultrasonic energy is applied to the liquid cleaning medium. Under appropriate conditions, ultrasonic energy generates cavitation within the liquid, which accelerates or enables the removal of residue, both soluble and insoluble, from the articles cleaned.

In another approach, the cleaning medium is a dense-phase fluid that is normally a gas at a reference operating temperature and 1 atmosphere pressure, and is pressurized to a pressure above its triple point at the reference operating temperature so that the gas is densified to a liquid or supercritical phase. The use of densified gases for cleaning and other forms of surface treatment on a wide variety of articles has been demonstrated to result in improved cleaning capability of many articles.

In one process application of dense phase gas cleaning, ultrasonic energy is introduced into the fluid to generate cavitation therein. Cavitation is defined as a process of forming low-pressure bubbles or cavities in a fluid by subjecting the fluid to high energy, either ultrasonic or mechanical in nature, to “rip” the fluid apart. As the local pressure in the fluid is rapidly dropped below its natural vapor pressure, a portion of the fluid vaporizes, leaving a multitude of small, low-pressure cavities. The amount of vapor in the cavity depends upon the speed with which the fluid is ripped apart, as well as other parameters. Under normal conditions, these bubbles collapse violently as external pressure causes the bubbles to contract. This collapse locally raises both the pressure and the temperature of the fluid. The high temperatures and pressures of a cavitating fluid cause the scrubbing action utilized in cleaning. The intensity of cavitation of a given fluid varies with many parameters. An important parameter which can affect the intensity of cavitation of dense phase fluids is the “overpressure” of the system, which is defined as the difference between the total system pressure and the saturation pressure at the temperature of the fluid. An increase in the overpressure of a system increases the intensity of cavitation, and the converse is true as well. Conventional liquid media for cavitation include water and a range of organic solvents such as isopropyl alcohol, acetone, other hydrocarbons, and others as well.

One convenient approach to introducing the required energy into the liquid phase is the use of an ultrasonic transducer. The ultrasonic transducer is built into the wall of the cleaning containment vessel, immersed into the cleaning fluid, or placed within a separate container. The ultrasonic energy produced by the transducer is directed into the cleaning fluid, to generate cavitation which accelerates or enables the cleaning of the article.

Ultrasonic transducers are operable and widely used in these applications. However, tests by the inventors leading to the present invention have shown that the effectiveness and efficiency of the ultrasonic transducers are less than might be expected. Indeed, quite often the mounting structures of the transducer assemblies become hot, indicating that acoustic energy is being dissipated as heat. There is accordingly a need for an improved approach to the use of ultrasonic transducers in cleaning operations. The present invention fulfills this need, and further provides related advantages.

### SUMMARY OF THE INVENTION

The present invention provides an approach for improving the effectiveness and efficiency of ultrasonic cleaning processes in pressurized dense-phase cleaning fluids. The functionality of the basic cleaning process is retained but is improved by increasing the transfer efficiency of ultrasonic energy from the source(s) to the fluid. This is accomplished by minimizing the acoustic impedance between the transducer and the fluid. The combination of transducer housing, transducer drive plates, and transducer housing gas pressures simultaneously allow minimal acoustic impedance while maintaining the mechanical strength needed to contain the high pressure liquefied gas.

In accordance with the invention, a cleaning system utilizing a pressurized dense-phase cleaning fluid comprises a cleaning containment vessel having a containment-vessel interior, a pressurization source in fluid communication with the containment-vessel interior to produce a cleaning pressure therein, and at least one ultrasonic energy source directing ultrasonic energy into the containment-vessel interior. Each ultrasonic energy source comprises a transducer housing having a transducer-housing interior, and an ultrasonic transducer within the transducer-housing interior. The transducer housing preferably includes a transducer drive plate, to which the transducer is affixed, and a transducer housing can that is affixed to the transducer drive plate but not to the transducer. The ultrasonic transducer directs a beam of ultrasonic energy through the transducer housing and into the containment-vessel interior. A gas-pressure source is in fluid communication with the transducer-housing interior to produce a pressure in the transducer-housing interior substantially equal to the cleaning pressure. The gas provided by the gas pressure source is a single gas or mixture of gases which do not condense at the temperature and pressure in the containment vessel interior.

One configuration of the ultrasonic energy source may comprise two ultrasonic energy sources, arranged in a substantially facing relationship to each other so that the ultrasonic energy of each ultrasonic transducer is directed toward the other ultrasonic transducer, through an interior region. That is, the two ultrasonic transducers are preferably coaxial and oppositely directed. Variations from this directly-opposed arrangement are acceptable, as long as the second ultrasonic transducer has a second beam component directed opposite to and intersecting the first ultrasonic energy beam. These ultrasonic transducers of the two energy sources desirably operate at different ultrasonic frequencies, but they may operate at the same ultrasonic frequency. The two or more ultrasonic energy sources may utilize a common gas-pressure source, inasmuch as they are preferably pressurized to the same gas pressure.

Other configurations of the ultrasonic energy sources may comprise more than two ultrasonic energy sources facing the interior region whose exterior is defined by the drive plates of the ultrasonic energy sources. These configurations may consist of three ultrasonic energy sources facing the interior region, four ultrasonic energy sources facing the interior region, five ultrasonic energy sources facing the interior region, or more than five ultrasonic energy sources facing the interior region.

The interior region between the ultrasonic energy sources is termed the “acoustically active region” of the interior of the containment-vessel interior.

There is typically a dense-phase cleaning fluid recirculation system that draws dense-phase cleaning fluid out of the containment vessel, cleans the dense-phase cleaning fluid, and introduces the cleaned dense-phase cleaning fluid back into the containment vessel. A cleaning fixture may be provided to move an article to be cleaned through the acoustically active region. In operation, there is a pressurized dense-phase cleaning fluid within the containment vessel. The pressurized dense-phase cleaning fluid is preferably liquefied carbon dioxide (CO₂), but it may be other pressurized dense-phase cleaning fluids such as, for example, nitrous oxide (N₂O), sulfur hexafluoride (SF₆), xenon, ammonia, helium, krypton, argon, ozone, methane, ethane, propane, butane, pentane, hexane, ethylene, propylene, tetrafluoromethane, chlorodifluoromethane, perfluoropropane, and mixtures thereof. The preferred mixtures of gases are carbon dioxide and nitrous oxide, and carbon dioxide and ozone. Optionally, additives may be added to the dense-phase cleaning fluid to enhance cleaning of articles, and/or to sterilize the articles of microbiological organisms. Examples of these additives include soy-methyl ester based solutions, water, hydrogen peroxide and water solutions thereof, carbon dioxide-soluble organo-peroxide additives such as benzoyl peroxide and peroxyacetic acid, and ozone generated in-situ. Hydrogen peroxide/water solutions are particularly effective for both cleaning and sterilizing articles.

The present approach may be utilized with a variety of different configurations. The cleaning containment vessel and the transducer housing may have no common wall. The cleaning containment vessel and the transducer housing may instead have a common wall. In one form, the cleaning system includes a system housing having a system-housing wall, and an interior wall having a first side facing the containment-vessel interior so that the containment vessel is defined by a first portion of the cleaning-containment-vessel wall and the interior wall, and a second side facing the ultrasonic transducer drive plate, so that the transducer housing is defined by a second portion of the system-housing wall and the interior wall. This configuration may be extended to two or more ultrasonic energy sources by having additional interior walls.

In practical cleaning systems, there is always a concern with maximizing the useful cleaning volume and minimizing the amount of volume occupied by the cleaning apparatus such as the ultrasonic transducers and their housings. In an embodiment utilizing the present approach and optimizing the volume utilization, a cleaning system utilizing a pressurized dense-phase cleaning fluid comprises a system housing having a system-housing exterior wall and a system-housing interior. An interior wall structure comprises part of the system housing interior, a first interior wall which is the exterior of the first transducer system drive plate, and a second interior wall which is the exterior of the second transducer system drive plate. The interior wall structure divides the system-housing interior into a first transducer-housing interior, a containment vessel interior, and a second transducer-housing interior. A pressurization source is in fluid communication with the containment-vessel interior to produce a cleaning pressure therein. A first ultrasonic transducer within the first transducer-housing interior directs a first beam of ultrasonic energy into the containment-vessel interior. A first gas-pressure source is in fluid communication with the first transducer-housing interior. The first gas-pressure source produces a first gas pressure in the first transducer housing interior substantially equal to the cleaning pressure. A second ultrasonic transducer is within the second transducer housing interior. The second ultrasonic transducer directs a second beam of ultrasonic energy into the containment-vessel interior. A second gas-pressure source (which may be the same as the first gas-pressure source) is in fluid communication with the second transducer housing interior. The second gas-pressure source produces a second gas pressure in the second transducer housing interior substantially equal to the cleaning pressure in the containment vessel interior.

In another embodiment, a cleaning system utilizing a pressurized dense-phase cleaning fluid comprises a cleaning containment vessel having a containment-vessel interior, and a pressurization source in fluid communication with the containment-vessel interior to produce a cleaning pressure therein. The cleaning system includes a first ultrasonic energy source directing a first ultrasonic energy beam into the containment-vessel interior, with the first ultrasonic energy source operating at a first-transducer frequency, and a second ultrasonic energy source directing a second ultrasonic energy beam into the containment-vessel interior, with the second ultrasonic energy source operating at a second-transducer frequency different from the first-transducer frequency. Compatible features discussed herein may be used in this embodiment as well.

The present approach provides a cleaning system that achieves efficient and effective use of ultrasonic supplementation to the cleaning and sterilization process. This system may be used in a wide variety of applications including, for example, cleaning of medical devices, sterilizing of medical devices and medical device components, sterilizing of organic and inorganic implants, cleaning of metal surfaces, cleaning of non-metallic surfaces, cleaning of metal parts, cleaning of optical surfaces and components, cleaning of semiconductor surfaces and components, cleaning of electronic assembly components, and cleaning and sterilizing of tubing. Other features and advantages of the present invention will be apparent from the following more detailed description of the preferred embodiments, taken in conjunction with the accompanying drawings, which illustrate, by way of example, the principles of the invention. The scope of the invention is not, however, limited to these preferred embodiments.

### BRIEF DESCRIPTION OF THE DRAWINGS

FIG. 1 is a schematic drawing of a first embodiment of a cleaning system;

FIG. 2 is a schematic drawing of a second embodiment of the cleaning system;

FIG. 3 is a schematic drawing of a third embodiment of the cleaning system;

FIG. 4 is a schematic drawing of a fourth embodiment of the cleaning system;

FIG. 5 is a schematic drawing of a fifth embodiment of the cleaning system; and

FIG. 6 is a schematic drawing of a sixth embodiment of the cleaning system.

### DETAILED DESCRIPTION OF THE INVENTION

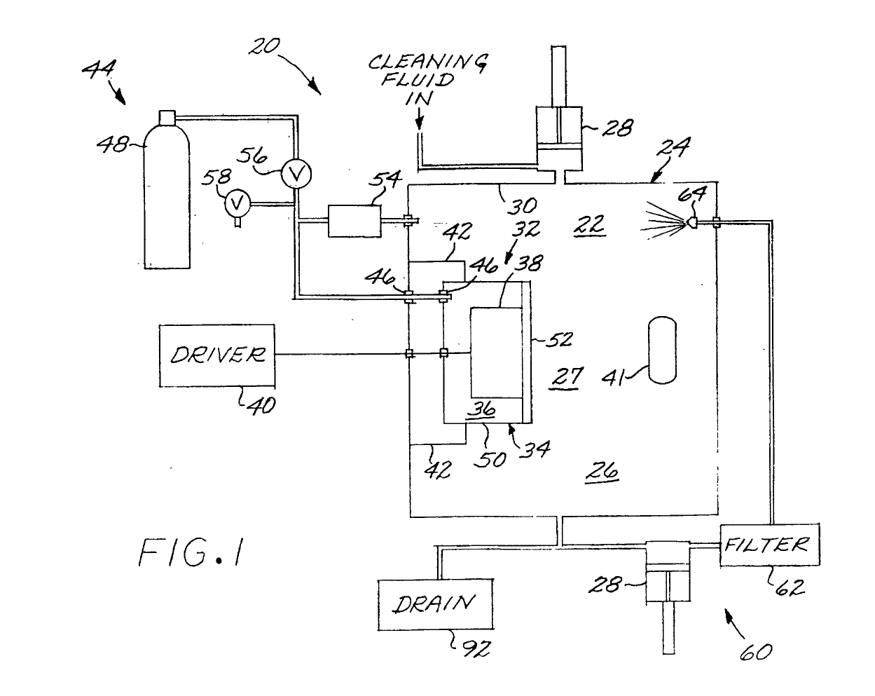

FIG. 1 depicts a cleaning system 20 utilizing a pressurized dense-phase cleaning fluid 22, preferably dense phase carbon dioxide, or a dense phase mixture of carbon dioxide and nitrous oxide, or a dense phase mixture of carbon dioxide and ozone in the liquid or supercritical state. As used herein, a “dense-phase cleaning fluid” is normally a gas at a reference operating temperature and 1 atmosphere pressure, and is pressurized to a pressure above its triple point at the reference operating temperature so that the gas is densified to a liquid or supercritical phase. The cleaning system 20 includes a cleaning containment vessel 24 having a containment-vessel interior 26 in which the dense-phase cleaning fluid 22 resides. At least one pressurization source 28 is in fluid communication with the containment-vessel interior 26 to produce a cleaning pressure therein on the dense-phase cleaning fluid 22. The cleaning pressure is typically no less than about 250 pounds per square inch, and may reach as high as about 5000 pounds per square inch. An exterior wall 30 of the cleaning containment vessel 24 is of sufficient strength and configuration to contain this cleaning pressure.

At least one ultrasonic energy source 32 directs ultrasonic energy into the containment-vessel interior 26. Each ultrasonic energy source 32 comprises a transducer housing 34 having a transducer-housing interior 36. The transducer housing 34 includes a transducer drive plate 52 and a transducer housing can 50 affixed to the transducer drive plate 52. An ultrasonic transducer 38 is positioned within the transducer housing 34 and affixed to an interior surface of the transducer drive plate 52. A transducer generator or driver 40 drives the ultrasonic transducer 38, causing the transducer drive plate 52 to vibrate, which transmits ultrasonic energy into the dense-phase cleaning fluid 22 and thence against an article 41 to be cleaned. The region to the right of the transducer drive plate 52 in the illustration of FIG. 1 is the acoustically active zone 27. (As used herein, “ultrasonic” includes energy at frequencies above about 3 kilohertz (kHz) and comprises both the range that is sometimes termed ultrasonic, about 3-100 kHz, and the range that is sometimes termed megasonic, about 100-2000 kHz, as well as higher frequencies.) In the embodiment of FIG. 1, the cleaning containment vessel 24 and the transducer housing 34 have no common wall. Instead, the transducer housing 34 is supported from the containment vessel 24 by a support 42.

A non-condensing gas-pressure source 44 is in fluid communication with the transducer-housing interior 36 via appropriate feedthroughs 46. The non-condensing gas-pressure source 44 pressurizes the transducer-housing interior 36 with a non-condensing gas pressure to a pressure substantially equal to that of the pressure of the dense-phase cleaning fluid 22. The density of the non-condensing gas is substantially less than that of the dense-phase cleaning fluid 22, so that the ultrasonic transducer 38 and its associated electronics are in a gas environment rather than a liquid environment. The gas used to pressurize the transducer-housing interior 36 is a “non-condensing” gas that remains in the gaseous state at the temperature and pressure of the dense-phase cleaning fluid 22 in the containment-vessel interior 26. The non-condensing gas-pressure source 44 may be of any operable non-condensing type. A regulated gas bottle 48 is illustrated as the gas-pressure source 44, but a pump or other gas-pressure source may be used. The gas-pressure source 44 produces a pressure in the transducer-housing interior 36 substantially equal to the cleaning pressure produced by the pressurization source 28. The pressure in the transducer-housing interior 36 is desirably with +/−100 pounds per square inch of that in the containment vessel interior 26. A differential-pressure monitor 54 may be provided to monitor the pressure difference between the containment-vessel interior 26 and the transducer-housing interior 34. The differential-pressure monitor 54 may also serve as a feedback controller by using its output to control a regulator valve 56 and a bleed valve 58 so that the differential pressure is maintained at substantially zero.

The balancing of the gas pressure within the transducer-housing interior 36 with the liquid cleaning pressure within the cleaning containment vessel 24 has three important consequences. First, the transducer drive plate 52 and the transducer housing can 50 of the transducer housing 34 need not be as thick and strong as they would otherwise have to be to support the pressure differential across the transducer housing 34. There is therefore less acoustic impedance between the ultrasonic transducer 38 and the transducer drive plate 52, on the one hand, and the dense-phase cleaning fluid 22 in the containment vessel interior 26. Indeed, the thickness of the transducer drive plate 52 is determined by acoustic efficiency rather than the pressure containment requirements of the system. Second, the efficiency of transfer of energy from the transducer generator 40 to the acoustic energy to the fluid is enhanced when the ultrasonic transducer 38 is backed by a gas. In view of the fact that the gas must be under pressure, in order to achieve a low acoustic impedance, the gas must be non-condensing. In this case, pressurized non-condensing gas in the transducer-housing interior 36 backs the ultrasonic transducer 38 to provide a more efficient means of transferring energy from the transducer generator 40 to the transducer 38 to the drive plate 52 and to the dense-phase cleaning fluid 22 when the transducer drive plate 52 of the ultrasonic energy source 32 moves toward the transducer-housing interior 36, termed the rarefaction portion of the transducer movement. Consequently, less energy is expended than if the transducer-housing interior 36 were filled with pressurized condensable gas or pressurized liquid. Third, the ultrasonic transducer 38 is not contacted by the dense-phase cleaning fluid 22 or any of the solvents, additives, or other chemicals that may be present in the dense-phase cleaning fluid 22, reducing the incidence of corrosion, shorting, or other damage to the ultrasonic transducer 38.

A dense-phase cleaning fluid recirculation system 60 draws dense-phase cleaning fluid out of the containment-vessel 26, pressurizes the fluid with the pressurization source 28 (which acts both as a circulating pump and as a pressurization source), cleans the dense-phase cleaning fluid by any appropriate means, here shown schematically as a filter 62, and introduces the cleaned dense-phase cleaning fluid back into the containment-vessel interior 26 by any appropriate means, here shown as a spray head 64. A dense-phase cleaning fluid drain 92 is provided to remove the dense-phase cleaning fluid from the system.

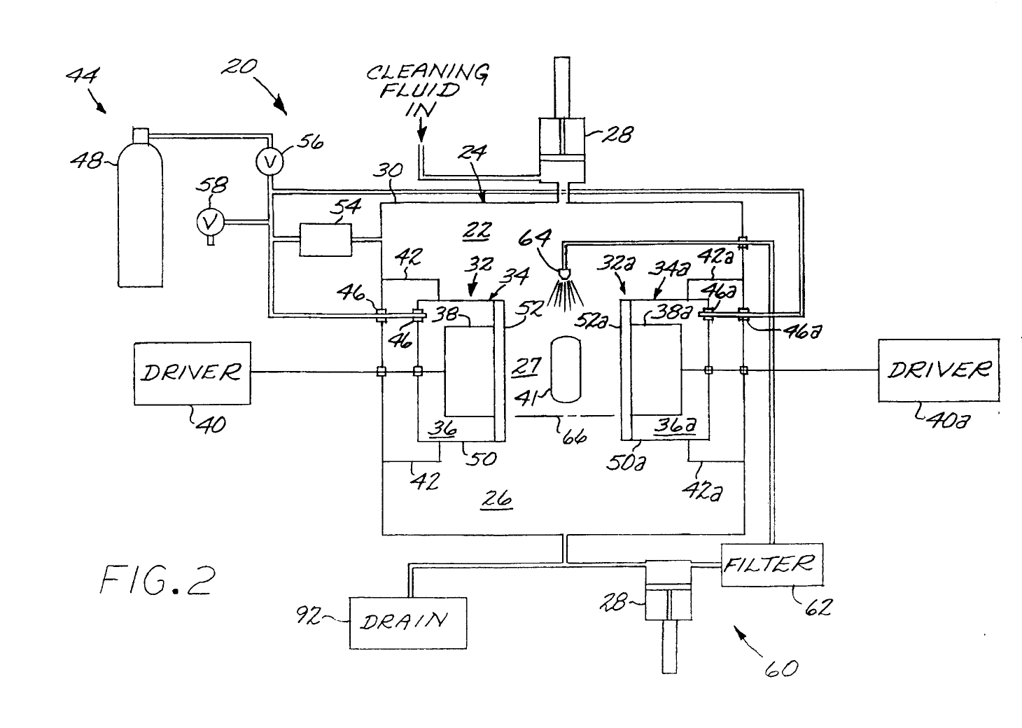

FIGS. 2-6 illustrate other embodiments of the cleaning system 20. Features common between the various embodiments of FIGS. 1-6 are assigned the same reference numerals (with an “a” suffix in the case of the second ultrasonic energy source found in some of the embodiments), and the prior or subsequent descriptions are incorporated into the discussion of the embodiment of each of the figures as appropriate. The features of the embodiments of FIGS. 1-6 may be used with each other to the extent that they are compatible.

In the embodiment of FIG. 2, there are two ultrasonic energy sources, the previously described ultrasonic energy source 32 and a second ultrasonic energy source 32a. The ultrasonic energy sources 32 and 32a are preferably arranged in a substantially facing relationship to each other so that the ultrasonic energy of the first ultrasonic energy source 32 is directed toward the second ultrasonic energy source 32a, and vice versa. That is, the compression phase from the first ultrasonic energy source 32 is directed along an axis 66 toward the article 41 in a first direction, and the compression phase of the second ultrasonic energy source 32a is directed along the same axis 66 toward the article 41 in a second direction opposite to the first direction. The region between the two transducer drive plates 52 and 52a is an acoustically active zone 27. The article 41 is thus placed between the two ultrasonic energy sources 32 and 32a in the acoustically active zone 27. Some of the same benefits may be obtained, but to a lesser degree, if the two ultrasonic energy sources 32 and 32a are not directly opposed, but where there is a geometric component of the compression phase from the second ultrasonic source directed opposite to and intersecting the compression phase from the first ultrasonic source.

The ultrasonic transducers 38 and 38a may operate at the same ultrasonic frequency or at different ultrasonic frequencies. If the ultrasonic transducers operate at different ultrasonic frequencies, the difference in the frequencies is typically from about 1 Hz to about 50 kHz, more preferably from about 1 Hz to about 4 kHz. For example, the two ultrasonic transducers 38 and 38a may operate at the same ultrasonic frequency of 20 kHz. They may instead operate at two different frequencies such as 16 and 20 kHz respectively, or 10 and 12 kHz respectively, for example.

The use of the two opposed ultrasonic energy sources 32 and 32a operating at different frequencies produces a more-uniform acoustic field, with less incidence of shadowing and better node/antinode formation, than achieved with the use of the single ultrasonic energy source 32 in the embodiment of FIG. 1.

The ultrasonic energy source 32a has a structure like that of the ultrasonic energy source 32, and preferably comprises a transducer housing 34a having a transducer-housing interior 36a. The ultrasonic transducer 38a is positioned within the transducer housing 34a. The ultrasonic transducer 38a, driven by a transducer generator 40a, directs a beam of ultrasonic energy through the transducer housing 34a and into the containment-vessel interior 26 toward the article 41 to be cleaned.

The transducer-housing interior 36a is pressurized to substantially the cleaning pressure of the dense-phase cleaning fluid 22 in the containment-vessel interior 26. Most conveniently and as illustrated, the transducer-housing interior 36a is pressurized by the same pressure source 44 as is the transducer-housing interior 36. Alternatively, a separate pressure source may be used for the transducer-housing interior 36a.

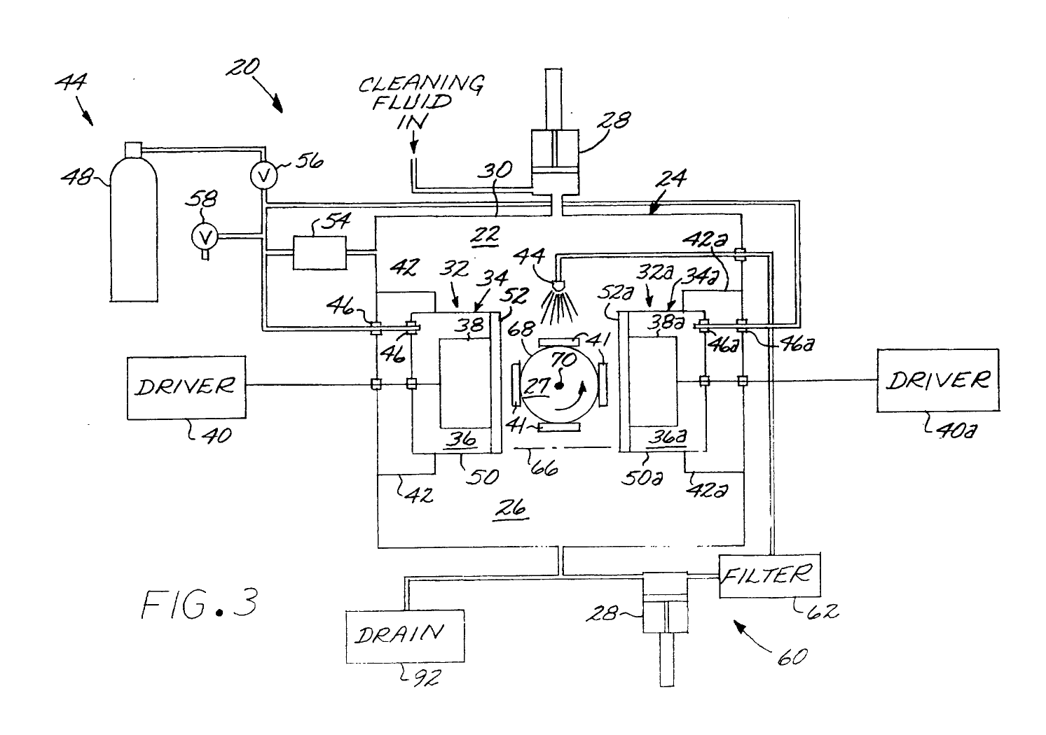

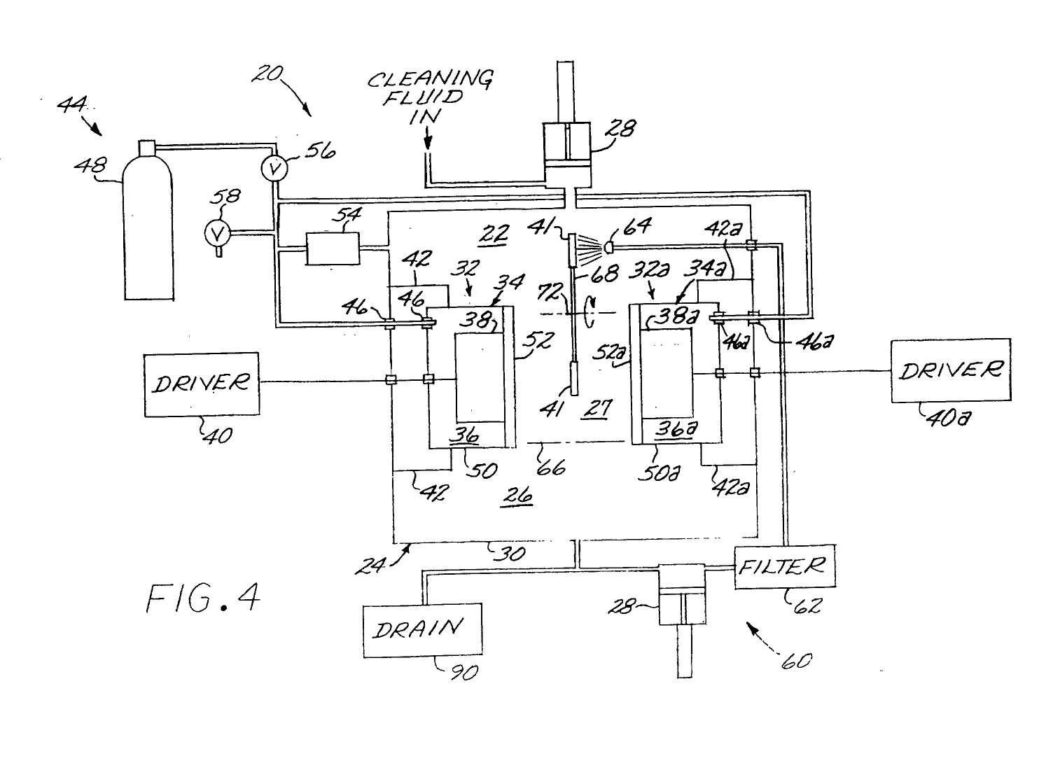

In the embodiments of FIGS. 3-4, structure to move the article 41 is added in addition to the features discussed in relation to FIG. 2, and the prior description is incorporated as to these features. In the embodiment of FIG. 3, multiple articles 41 are mounted to a cleaning fixture 68 that moves the articles 41 to be cleaned through the acoustically active zone 27 by rotation about an axis 70 extending out of the plane of the illustration. In addition, jets of dense-phase cleaning fluid may be directed toward the rotating article 41. In the embodiment of FIG. 4, the articles 41 are mounted on the cleaning fixture 68 that rotates about an axis 72 that lies in the plane of the illustration such that the articles 41 are periodically rotated into and out of the acoustically active zone 27. In addition, jets of dense-phase cleaning fluid may be directed from a spray heat 64 toward the rotating article 41. The speed of rotation of the articles depicted in FIGS. 3-4 varies from 1-10,000 revolutions per minute.

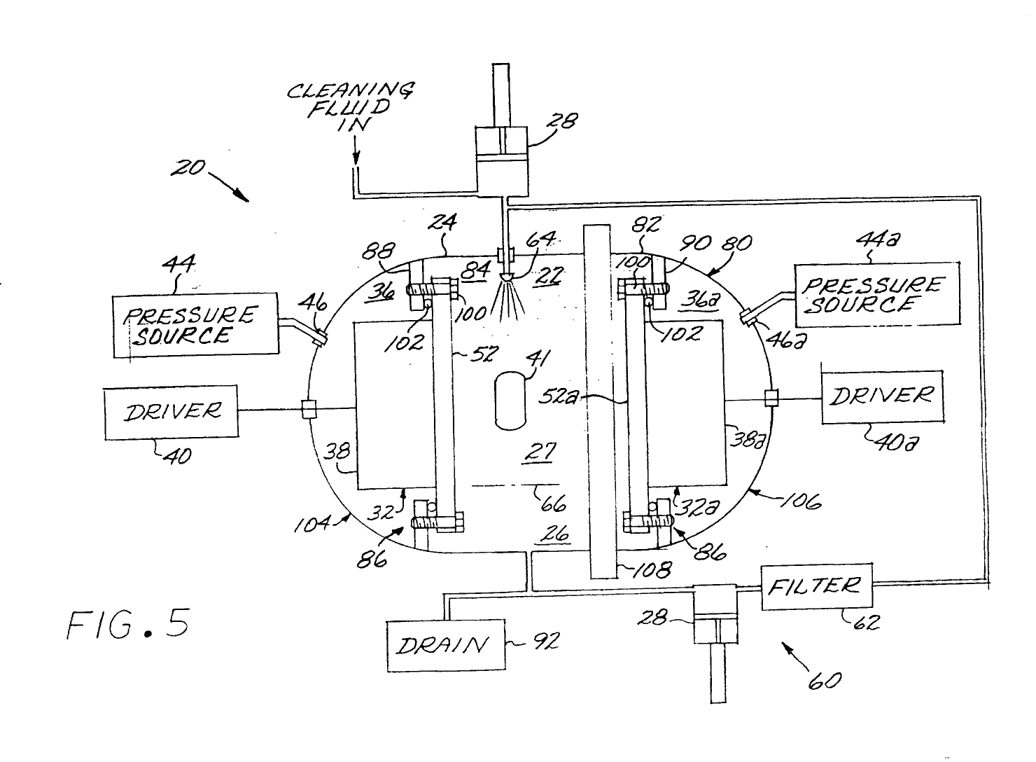

The embodiment of FIG. 5 is of a different configuration, although features common with those of the embodiments of FIGS. 1-4 are commonly numbered and the prior discussion is incorporated here. For practical commercial embodiments of the cleaning system, it is preferred that the space within the cleaning containment vessel 24 be utilized as efficiently as possible so as to maximize the volume available for the articles 41 to be cleaned. Because the cleaning containment vessel 24 is a pressure vessel to contain the pressurized dense-phase cleaning fluid, there is a substantial cost associated with making the cleaning containment vessel larger than necessary. The cleaning system 20 of FIG. 5 incorporates the structures and advantages of the other embodiments, but makes more efficient use of the space within the cleaning containment vessel 24. In describing the cleaning system 20 of FIG. 5, some new elements are discussed, but the reference numerals associated with previously discussed elements are also included. This cleaning system 20 uses the two ultrasonic energy sources 32 and 32a as discussed in relation to FIGS. 2-4, but it may be implemented with one or with more than two ultrasonic energy sources.

The cleaning system 20 of FIG. 5 utilizes the pressurized dense-phase cleaning fluid 22 and has a system housing 80 with a system-housing exterior wall 82 and a system-housing interior 84. An interior wall structure 86 includes a first interior wall 88 and a second interior wall 90. The interior wall structure 86 divides the system-housing interior 84 into the first transducer housing interior 36, the containment vessel interior 26, and the second transducer housing interior 36a. That is, the first transducer housing interior 36 shares the common first interior wall 88 with the containment vessel interior 26, and the second transducer housing interior 36a shares the common second interior wall 90 with the containment vessel interior 26. Thus, for each of the two interior walls 88 and 90, a first side of the wall faces the containment-vessel interior 26 so that the containment vessel is defined by a first portion of the cleaning-containment-vessel wall and the interior wall, and a second side faces the ultrasonic transducer drive plates 52 and 52a, so that the transducer housing is defined by a second portion of the system-housing wall, the transducer drive plate 52 or 52a, and the interior wall.

The pressurization source 28 is in fluid communication with the containment-vessel interior 26 to produce the cleaning pressure therein.

The first ultrasonic transducer 38 is within the first transducer-housing interior 36. The first ultrasonic transducer 38 directs the first beam of ultrasonic energy into the acoustically active zone 27 of the containment-vessel interior 26. The first gas-pressure source 44 is in fluid communication with the first transducer-housing interior 36. The first gas-pressure source 44 produces a first pressure in the first transducer housing interior 36 substantially equal to the cleaning pressure in the dense-phase cleaning fluid 22 within the containment vessel interior 26.

The second ultrasonic transducer 38a is within the second transducer-housing interior 36a. The second ultrasonic transducer 38a directs the second beam of ultrasonic energy into the acoustically active zone 27 of the containment-vessel interior 26. The second gas-pressure source 44a is in fluid communication with the second transducer-housing interior 36a. The second gas-pressure source 44a produces a second pressure in the second transducer housing interior 36a substantially equal to the cleaning pressure in the dense-phase cleaning fluid 22 of the within the containment vessel interior 26. In this embodiment, the first gas-pressure source 44 and the second gas-pressure source 44a are illustrated as different gas-pressure sources, but they may be the same gas pressure source as illustrated in the embodiments of FIGS. 2-4.

In the embodiment of FIG. 5, the transducer drive plates 52 and 52a are affixed to the respective first interior wall 88 and second interior wall 90 by fasteners 100, with seals 102 therebetween.

In this practical embodiment, the first transducer-housing interior 36 and most of the containment vessel interior 26 (in which the dense-phase cleaning fluid 22 and the articles 41 are located) is in a pressure vessel body 104, while the second transducer-housing interior 36a is in a pressure vessel door 106, with a seal structure 108 therebetween which is sealed when the door 106 is closed.

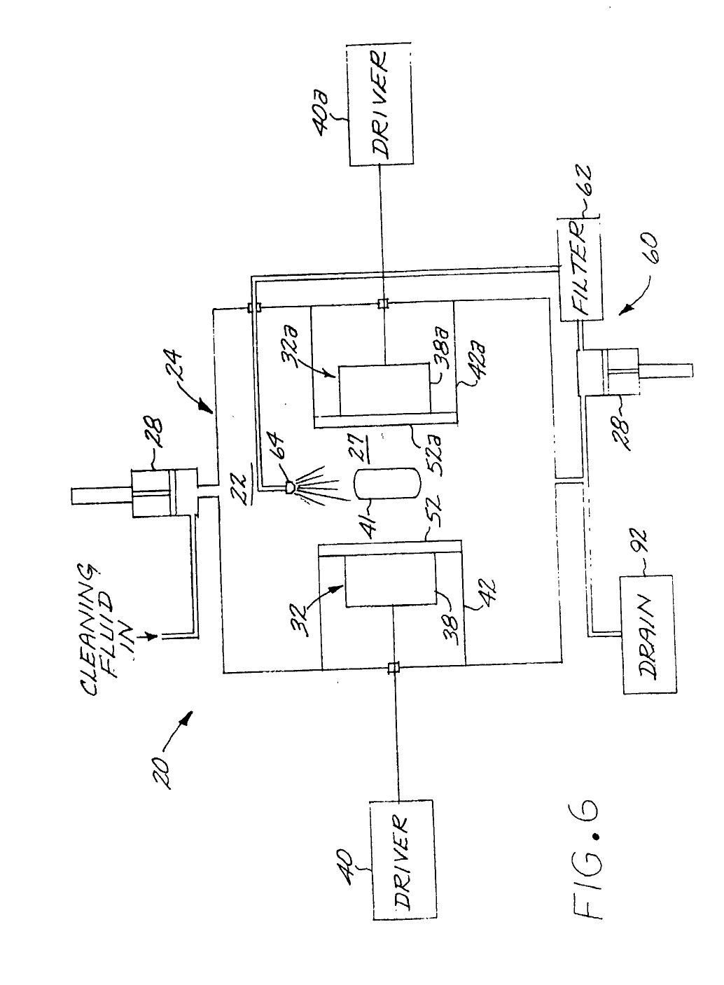

The embodiment of FIG. 6 is similar to that of FIG. 2, except that the ultrasonic transducers 38 and 38a are not enclosed by any transducer housing as in the embodiments of FIGS. 1-5. That is, the ultrasonic transducers 38 and 38a are within the containment vessel interior 26 and are immersed directly in the dense-phase cleaning fluid 22, in a facing relation to each other. This embodiment is operable but less preferred than the embodiments of FIGS. 1-5.

### EXAMPLE 1

The approach of FIG. 6 was practiced. The transducers 38 and 38a were immersed directly in the dense-phase cleaning fluid 22, which was carbon dioxide. The articles 41 were test coupons coated with mineral oil and particle slurry. The first transducer 38 was operated at 16 kHz frequency and 2 kW (kilowatts) power. The second transducer 38a was operated at 20 kHz frequency and 2 kW power. The average temperature was 12° C. The average pressure was 51.2 bar. The average overpressure was 5 bar. The processing time was 10 minutes. The result was that all mineral oil was removed, and all particles greater than 3 micrometers in size were removed.

### EXAMPLE 2

The approach of FIG. 6 was practiced. That is, the transducers 38 and 38a were immersed in the dense-phase cleaning fluid 22, which was carbon dioxide. The articles 41 were stainless steel test coupons coated with particles. The first transducer 38 was operated at 16 kHz frequency and 2 kW (kilowatts) power. The second transducer 38a was operated at 20 kHz frequency and 2 kW power. The average temperature was 14.9° C. The average pressure was 56.2 bar. The average overpressure was 8.3 bar. The processing time was 15 minutes. The result was that all particles greater than 1 micrometer in size were removed.

### EXAMPLE 3

The ultrasonics system used to embody the process shown in FIG. 1 is based on a 16 kHz magnetostrictive transducer system, consisting of five individual transducers rated to each deliver 400 watts of acoustic power, yielding a transducer system capable of delivering 2 kilowatts of acoustic power. Each transducer was affixed to the transducer drive plate 52, which was made of 10 gauge 316 stainless steel. The transducer housing can 50 was made of 10 gauge 316 stainless steel. The transducer housing 34 was cylindrical with outer dimensions of 12.75 inches diameter and 6.75 inches height. The transducer housing can 50 was designed to accommodate both power and gas feedthroughs. The ultrasonic transducer system was driven by an AGC generator rated to 2 kilowatts at 16 kHz.

In this example, the articles 41 were inoculated with test bacteria and placed in the acoustically active zone 27 in front of the transducer drive plate 52. The transducer 38 was operated at 16 kHz frequency and 2 kW (kilowatts) power. The average temperature was 6.5° C. The average pressure was 43.3 bar. The average overpressure was 3.1 bar. Thirty-eight milliliters of 30 percent by weight hydrogen peroxide solute in water was added to the 80 liter cleaning system. The processing time was 30 minutes. The result was that sterilization of test articles was achieved.

### EXAMPLE 4

The embodiment of FIG. 2 was reduced to practice using a cleaning containment vessel of about 80 liters in size and two facing ultrasonic transducers 38 and 38a, one operating at 16 kHz and the other at 20 kHz, and with a spacing therebetween of about 5 inches. The pressurization source 28 was operated simultaneously with the transducers. The cleaning pressures in the containment vessel interior ranged from 30 bar to 60 bar in different trials. The dense-phase cleaning fluid was carbon dioxide, alone and with various additives such as water, mixtures of hydrogen peroxide and water, and soy-based methylated esters. Oils, greases, particulate matter, and spores were removed from the articles. Spores were destroyed by the rupturing of cell walls and/or killing the cells with the additives.

The articles 41 were test coupons coated with particles. The first transducer 38 was operated at 16 kHz frequency and 2 kW (kilowatts) power. The second transducer 38a was operated at 20 kHz frequency and 2 kW power. The average temperature was 10.4° C. The average pressure was 47.6 bar. The average overpressure was 3.2 bar. The processing time was 10 minutes. The result was that all particles greater than 1 micrometer in size were removed, which was the level of optical detection.

### EXAMPLE 5

Example 4 was repeated, except that the average temperature was 10.4° C. The average pressure was 47.2 bar. The average overpressure was 2.7 bar. The processing time was 10 minutes. A sterilant additive of 38 milliliters of 30 weight percent hydrogen peroxide in water as added to the 80 liter vessel. The result was that all particles greater than 1 micrometer in size were removed, which was the level of optical detection.

### EXAMPLE 6

Example 4 was repeated, except that the articles 41 were test coupons coated with approximately 10⁶ organisms of bacilus stearothermophilus. The average temperature was 5.1° C. The average pressure was 35.2 bar. The average overpressure was 5.9 bar. The processing time was 10 minutes. The result was that the test coupons were sterile.

### EXAMPLE 7

Example 4 was repeated, except that the articles 41 were coupons coated with approximately 10⁶ organisms of bacilus stearothermophilus. The average temperature was 14.8° C. The average pressure was 55.0 bar. The average overpressure was 5.3 bar. The processing time was 10 minutes. A sterilant additive of 38 milliliters of 30 weight percent hydrogen peroxide in water as added to the 80 liter vessel. The result was that the coupon was sterile.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A cleaning system utilizing a pressurized dense-phase cleaning fluid, comprising:
a cleaning containment vessel having a containment-vessel interior;
a pressurization source in fluid communication with the containment-vessel interior to produce a cleaning pressure therein; and
at least one ultrasonic energy source directing ultrasonic energy into the containment-vessel interior, each ultrasonic energy source comprising
a transducer housing having a transducer-housing interior,
an ultrasonic transducer within the transducer-housing interior, the ultrasonic transducer directing a beam of ultrasonic energy through the transducer housing and into the containment-vessel interior, and
a gas-pressure source in fluid communication with the transducer-housing interior, the gas-pressure source producing a pressure in the transducer-housing interior substantially equal to the cleaning pressure.

2. The cleaning system of claim 1, wherein the transducer housing comprises
a drive plate to which the ultrasonic transducer is affixed, and
a transducer housing can that is affixed to the drive plate but not to the ultrasonic transducer.

3. The cleaning system of claim 1, further including
a dense-phase cleaning fluid recirculation system that draws the dense-phase cleaning fluid out of the containment vessel, cleans the dense-phase cleaning fluid, and introduces the cleaned dense-phase cleaning fluid back into the containment vessel.

4. The cleaning system of claim 1, wherein the at least one ultrasonic energy source comprises two ultrasonic energy sources.

5. The cleaning system of claim 4, wherein the two ultrasonic energy sources are arranged in a substantially facing relationship to each other so that the ultrasonic energy of a first ultrasonic transducer is directed toward a second ultrasonic transducer.

6. The cleaning system of claim 4, wherein the ultrasonic transducers operate at different ultrasonic frequencies.

7. The cleaning system of claim 4, wherein the ultrasonic transducers operate at frequencies differing from each other by from about 1 Hz to about 50 kHz.

8. The cleaning system of claim 4, wherein the first ultrasonic transducer is a 16 kHz ultrasonic transducer and the second ultrasonic transducer is a 20 kHz ultrasonic transducer.

9. The cleaning system of claim 4, wherein the first ultrasonic transducer is a 10 kHz ultrasonic transducer and the second ultrasonic transducer is a 12 kHz ultrasonic transducer.

10. The cleaning system of claim 1, further including a cleaning fixture that moves an article to be cleaned through the beam of ultrasonic energy.

11. The cleaning system of claim 1, wherein the cleaning containment vessel and the transducer housing have no common wall.

12. The cleaning system of claim 1, wherein the cleaning containment vessel and the transducer housing have a common wall.

13. The cleaning system of claim 1, further including a dense-phase cleaning fluid within the containment-vessel interior.

14. The cleaning system of claim 10, wherein no additives are mixed with the dense-phase cleaning fluid.

15. The cleaning system of claim 10, wherein an additive is mixed with the dense-phase cleaning fluid.

16. The cleaning system of claim 10, wherein an additive is mixed with the dense-phase cleaning fluid, the additive selected from the group consisting of soy-methyl ester based solutions, water, hydrogen peroxide and water solutions thereof, carbon dioxide-soluble organo-peroxide additives such as benzoyl peroxide and peroxyacetic acid, and ozone generated in-situ.

17. The cleaning system of claim 1, further including
a dense-phase cleaning fluid within the containment-vessel interior, wherein the dense-phase cleaning fluid comprises a fluid selected from the group consisting of carbon dioxide, nitrous oxide, sulfur hexafluoride, xenon, ammonia, helium, krypton, argon, methane, ethane, propane, butane, pentane, hexane, ethylene, propylene, tetrafluoromethane, chlorodifluoromethane, perfluoropropane, and mixtures thereof.

18. A cleaning system utilizing a pressurized dense-phase cleaning fluid, comprising:
a cleaning containment vessel having a containment-vessel interior;
a pressurization source in fluid communication with the containment-vessel interior to produce a cleaning pressure therein;
a first ultrasonic energy source directing a first ultrasonic energy beam into the containment-vessel interior, the first ultrasonic energy source comprising a first ultrasonic transducer operating at a first-transducer frequency; and
a second ultrasonic energy source directing a second ultrasonic energy beam into the containment-vessel interior, the second ultrasonic energy source comprising a second ultrasonic transducer operating at a second-transducer frequency different from the first-transducer frequency.

19. The cleaning system of claim 18, wherein the second ultrasonic energy beam and the first ultrasonic energy beam are substantially coaxial and oppositely directed.

20. The cleaning system of claim 18, further including
a dense-phase cleaning fluid recirculation system that draws the dense-phase cleaning fluid out of the containment vessel, cleans the dense-phase cleaning fluid, and introduces the cleaned dense-phase cleaning fluid back into the containment vessel.

21. The cleaning system of claim 18, further including
a cleaning fixture that moves an article to be cleaned through the beam of ultrasonic energy.

22. The cleaning system of claim 18, further including
a first transducer housing containing the first ultrasonic transducer, and
a second transducer housing containing the second ultrasonic transducer.

23. The cleaning system of claim 22, wherein the cleaning containment vessel, the first transducer housing, and the second transducer housing have no common wall.

24. The cleaning system of claim 22, wherein the cleaning containment vessel and the first transducer housing have a common wall, and wherein the cleaning containment vessel and the second transducer housing have a common wall.

25. The cleaning system of claim 18, further including
a dense-phase cleaning fluid within the containment-vessel interior.

26. The cleaning system of claim 18, further including
a dense-phase cleaning fluid within the containment-vessel interior, wherein the dense-phase cleaning fluid comprises a fluid selected from the group consisting of carbon dioxide, nitrous oxide, sulfur hexafluoride, xenon, ammonia, helium, krypton, argon, methane, ethane, propane, butane, pentane, hexane, ethylene, propylene, tetrafluoromethane, chlorodifluoromethane, perfluoropropane, and mixtures thereof.

27. The cleaning system of claim 18, wherein the first-transducer frequency and the second-transducer frequency are different from each other by from about 1 Hz to about 50 kHz.

28. The cleaning system of claim 18, wherein the first-transducer frequency is 16 kHz and the second-transducer frequency is 20 kHz.

29. The cleaning system of claim 18, wherein the first-transducer frequency is 10 kHz and the second-transducer frequency is 12 kHz.
